(19) United States
(12) Patent Application Publication
(10) Pub. No.: US 2026/0307295 A1
(43) Pub. Date: Oct. 8, 2026

(54) UNIT AND METHOD FOR THERMAL TREATMENT OF SLABS MADE OF STONE OR STONE-LIKE AGGLOMERATE MATERIAL AND PLANT FOR MANUFACTURING SLABS MADE OF STONE OR STONE-LIKE AGGLOMERATE MATERIAL

(71) Applicant: Dario TONCELLI, Bassano del Grappa (VI) (IT)

(72) Inventor: Dario TONCELLI, Bassano del Grappa (VI) (IT)

(21) Appl. No.: 19/476,217

(22) PCT Filed: Apr. 8, 2024
(86) PCT No.: PCT/IB2024/053420

§ 371 Date: Oct. 17, 2025

(30) Foreign Application Priority Data
Apr. 19, 2023 (IT) 102023000007638

(51) Int. Cl. B28B 11/24

(52) U.S. Cl. CPC B28B 11/24

(57) ABSTRACT

Unit and method for the thermal treatment of slabs made of stone or stone-like agglomerate material obtained from at least one mix comprising an organic binder and stone or stone-like granulated and/or pulverized materials. The unit is intended to be positioned in a plant for manufacturing such slabs, downstream of a station for catalysis of the organic binder and hardening of the at least one mix at a predefined catalysis temperature and upstream of a station for final cooling of the slabs. The unit includes comprises a first heating station located at the front and including heating means to heat the slabs up to a predefined heating temperature higher than the predefined catalysis temperature and a second cooling station located downstream of the first heating station and comprising cooling means to cool the slabs down to a predefined cooling temperature.

The present invention relates to the technical field for the production of articles, preferably slabs, made of stone or stone-like agglomerate material and relates in particular to a unit and a method for thermal treatment of such slabs.

The invention also relates to a plant for manufacturing slabs made of stone or stone-like agglomerate material comprising the aforementioned thermal treatment unit.

In the technical field relating to the production of articles and slabs made of stone or stone-like agglomerate material, the agglomerate is generally obtained by means of distribution, compaction, preferably by means of vacuum vibro-compression, and hardening of at least one mix.

In particular, the slabs may be made by means of the known Bretonstone® process or by means of rolling, pressing and extrusion.

The mix contains mainly a binder and granulated material, namely granules and/or powders, consisting of stone or stone-like material.

The binder is preferably of an organic type and consists of a hardening resin chosen from the group comprising polyester, acrylic, epoxy and polyurethane resins, but also resins of natural and plant origin; typically a polyester resin is used.

Said polyester resin usually has, added to it, a catalyst or an accelerating agent necessary for performing the catalysis of the resin and hardening of the mix, as described below.

Moreover, the granulated or powder material consists generally of natural minerals which may of a siliceous nature, namely derived from quartz, granite, porphyry, basalt, quartzites, silica sands, or of a calcareous nature, namely derived from marble, dolomite, coloured stones, etc.

Alternatively, the granulated or powder material may consist of synthetic minerals, such as frits, or amorphous glass, and/or expanded material, such as expanded glass or expanded clay or expanded natural silicates.

The mix may also contain fillers, further binders, additives and colouring agents. In particular, mineral fillers are materials used in combination with the resin in order to form the so-called binding paste.

Nowadays, in order to produce slabs with a particularly attractive aesthetic appearance appreciated on the market, the mixes have a volumetric resin content of up to about 25-26% of the overall volume of the mix, namely a resin weight content of up to about 12-13% of the overall weight of the mix.

In the Bretonstone® process, the mix is distributed initially on a temporary support, such as a base or a tray of a mould; then the mix is subjected to vibration with simultaneous pressing or compression under a vacuum (vacuum vibro-compression) and finally hardened.

As mentioned, the mix hardening step is preferably performed by means of catalysis of the organic binder, i.e. the resin, inside heating ovens.

The mixes, contained inside sheaths or casings formed by the tray or by a cover which encloses the tray at the top, or inside casings formed by paper or plastic film, are inserted in the heating ovens in order to perform the hardening step.

The heating ovens generally comprise a frame with a series of pairs of heating shelves which define respective housings for the sheaths with the mixes, each of the shelves comprising at least one internal circuit inside which there flows a hot fluid, namely, a fluid with a temperature which is usually maintained preferably in the range of between 90° C. and 130° C.

Furthermore, the heating ovens comprise at least one circuit for supplying the hot fluid, connected to the internal circuits of the heating shelves.

For each pair of shelves a first shelf, or bottom shelf, and a second shelf, or top shelf, are defined.

Usually, the bottom shelves are positioned at a set height or at a variable height, and the top shelves, associated with the corresponding bottom shelves, are movable with respect to the bottom shelves so as to vary the heights of the housings and allow the insertion of the sheaths containing the compacted mix.

Each casing positioned inside the respective housing is supported by the bottom heating shelf; after positioning of the casing with the mix, the top heating shelf is moved so as to rest on its surface.

The mix contained in the casing is thus heated uniformly owing to the hot fluid which flows inside the internal circuits of the respective heating shelves.

In this way, the transmission of the heat between the pairs of shelves, namely the bottom shelf and the top shelf, and the casings with the mixes takes place essentially by means of thermal conduction.

Alternatively, the transmission of heat between the heating shelves and the casings with the mixes may also take place by means of irradiation, or by means of convection by a hot air flow.

The duration of the catalysis step depends mainly on the type of resin used in the mixes, the type and the quantity of catalyst and accelerating agent contained in the resin and the thickness of the hardened slab to be obtained.

For example, for a slab obtained from a mix containing a polyester resin to which catalytic agents and accelerating agents have been suitably added, the average duration of the catalysis step is close to thirty minutes.

An example of a heating oven for performing the catalysis and hardening of the slabs is described in Italian patent application No. 102022000006776, in which the supply of the hot fluid to the internal circuits is regulated by means of respective motorized valves connected a control unit.

During the catalysis step, a temperature, defined as predefined catalysis temperature in the context of the present description, is reached, and at this temperature the catalysis reaction of the resin and consequently hardening of the mix takes place.

Said temperature is obtained at least partly from the said catalysis reaction, which is exothermic and is triggered normally at about 80° C., and mainly from the heat released by the heating shelves.

Nowadays, the predefined catalysis temperature is usually comprised between 90° C. and 120° C. and preferably between 105° C. and 115° C. The slabs output from the catalysis oven have a temperature within the range indicated above.

Such temperature of the slabs is a few degrees higher than the output temperature of the slabs from the catalysis ovens used in the past years, this with the aim of reducing the catalysis time and increasing the productivity of the entire slab production plant.

Moreover, said temperature is higher than the glass transition temperature (Tg) of the binding resin, namely the temperature below which an amorphous material has the characteristics of a glass-like material, passing from a soft/rubbery state (for a temperature higher than the Tg) to a solid state (for a temperature lower than the Tg).

The glass transition temperature is, in turn, higher than the heat deflection temperature (HDT) of the resin, namely the temperature at which a resinous material may be stressed for a short period of time in order to cause deformation thereof.

During the catalysis step, moreover, dimensional shrinkage, i.e. a reduction in the size of the slabs, takes place, this being due to the volumetric shrinkage of the binding resin during the hardening step.

In the table below, two examples of dimensional shrinkage values of slabs, respectively containing a volume of resin equal to 16% and 26% and subject to a volumetric shrinkage of the resin equal to 7% and 8% with respect to the overall volume, are shown.

Volumetric resin shrinkage (%)

| | |
|---|---|
| 7 | 8 |

| | |
|---|---|
| Volume of | Shortening of a slab |
| resin (%) | with a length of 350 cm |

| | | |
|---|---|---|
| 16 | 1.35 cm | 1.54 cm |
| 26 | 2.09 cm | 2.40 cm |

As can be noted from the table, the volumetric and dimensional shrinkage of the slabs is significant and must be duly taken into account during the slab manufacture process.

At the end of the catalysis step performed in the heating ovens, the slabs are transferred to a further station in order to undergo a final cooling step down to room temperature or in any case to a temperature lower than the predefined catalysis temperature.

Before transferring the slabs to the cooling station, the bottoms and covers of any sheaths are removed from the hardened slabs exiting the heating oven.

The cooling station is formed preferably by a cooling tower also comprising a series of shelves which define respective housings for the slabs, inside which air at room temperature is circulated, for example using fans.

The cooling step thus performed has a duration of about forty minutes.

Alternatively, the cooling station may be formed by a tunnel with a cooling transport system formed, for example, by rollers provided with fans/ventilators for creating a flow of air at room temperature.

Furthermore, the plant for manufacturing slabs of agglomerate material comprises, downstream of the cooling station, a station for machining the surfaces of the slabs, i.e. a station for calibration and/or smoothing and/or polishing of the slab surfaces.

The technical solutions disclosed above, although widely used in the field, are not without certain drawbacks.

A first drawback consists in the fact that air pockets may be formed between the surfaces of the heating shelves and the surfaces of the sheaths, mainly due to differences in thickness present in the layers of mix or undulations or irregularities in the surfaces of the mixes.

The undulations are due mainly to the presence of accumulated/segregated amounts of resin, namely zones where is a greater concentration of resin on the surfaces of the slabs following compaction of the mixes.

The presence of air pockets results in non-uniform contact between the heating shelves and the sheaths, making it difficult to control the heat flow, which in this case occurs by irradiation and no longer by conduction, from the heating shelves to the mixes. Consequently, control of the catalysis reaction is particularly difficult.

Furthermore, the presence of segregated amounts of resin may result in a lack of uniformity in the catalysis reaction in different zones of the slab surfaces and the consequent formation of bowing in the slabs due to the different volumetric shrinkage of the resin in these zones.

The different volumetric shrinkage of the resin may also arise between the outer surfaces and the central body of the slabs and may result, following cooling, in particularly intense internal tension which may result in the formation of cracks.

These cracks may arise both during the slab manufacturing process and during the subsequent machining of the slabs.

A further drawback consists in the fact that the heating shelves in the oven may differently heat the top portion and the bottom portion of the slabs, resulting in the hardening thereof within different periods of time.

This drawback may cause warping of the slabs and the formation of concavities or convexities therein, thus worsening the formation of bowing in the slabs.

The presence of non-uniform, irregular or undulating zones, differences in thicknesses, bowing or concavities/convexities in the surfaces of the slabs must be remedied by means of the removal of material during the following calibration step.

This latter step allows slabs with substantially flat surfaces to be obtained, before the further smoothing and/or polishing steps.

However, this procedure has the following drawbacks:
the rough slab obtained following compaction and hardening must have a thickness substantially greater than the thickness which the finished slab will have following the calibration step, thus resulting in a significant wastage of material and energy;
the calibration step results in the formation of waste material which must be disposed of, in particular in the case where the rough slabs have a thickness which is particular greater than the thickness of the calibrated slabs;
a calibration step involving the removal of a greater amount of material from the slabs results in greater wear of the machining tools and an increase in the overall slab manufacturing times and costs.

For example, compared to a finished slab with a thickness of 20 mm as required by the market, the thickness of the slab exiting the cooling station may be between about 24 mm and 28 mm.

In the best of cases, if the manufacturing process is particularly well controlled and the operators responsible for the process are particularly skillful and expert, the thickness of the slabs exiting the cooling tower could also be equal to about 24-25 mm, so as to limit the removal of material during the calibration process to a thickness of about 2-2.5 mm for each surface of the slab.

Generally, the slabs produced by means of the plant and the method described above, have a thickness when exiting the cooling tower of about 26 mm.

A further drawback consists in the fact that, after the cooling step, a quantity of free and non-crosslinked styrene monomer (polyester resin component) normally of between 5 and 20 ppm (with respect to the overall weight of the slab) remains in the catalysed slabs as described above, in particular in the slabs containing a polyester resin.

Nowadays, the environmental control authorities tend to require a reduction of the residual amount of free and non-crosslinked styrene monomer.

The main object of the present invention is to provide therefore a unit and a method for the thermal treatment of slabs made of stone or stone-like agglomerate material and a plant for manufacturing slabs made stone or stone-like agglomerate material which are able to solve the drawbacks indicated above.

A particular task of the present invention is to provide a unit and a method for thermal treatment of slabs which are able to reduce the formation of bowing or concave/convex zones in the surfaces of the slabs.

A further task of the present invention is to provide a thermal treatment unit and method which are able to reduce and limit the calibration operations to be performed downstream of the cooling station on the surfaces of the hardened and cooled slabs.

Another task of the present invention is to provide a unit and method for thermal treatment of slabs, which are able to limit the material to be removed from the surfaces of the slabs during the calibration step, and therefore the amount of waste material to be disposed of.

A further task of the present invention is to provide a unit and a method for thermal treatment of slabs, which are able to reduce or eliminate the formation of internal tension in the slabs.

Another task of the present invention is to provide a plant for manufacturing slabs of the type described above which is able to reduce the overall costs and time for manufacture of the slabs.

A further task of the present invention is to provide a plant for manufacturing slabs of the type described above which is able to reduce the amount of waste material to be disposed of, which is produced during machining or calibration of the slab surfaces.

Another task of the present invention is to provide a plant for manufacturing slabs containing polyester resin, which is able to reduce the residual amount of free and non-crosslinked styrene monomer present in the slabs, following cooling, to at least a value not higher than 5 ppm with respect to the overall weight of the slab.

The main object and tasks described above are achieved with a unit and method for thermal treatment of slabs made of stone or stone-like agglomerate material in accordance with claim 1 and claim 27, respectively, and with a plant for manufacturing slabs made of stone or stone-like agglomerate material in accordance with claim 13.

In order to illustrate more clearly the innovative principles of the present invention and its advantages compared to the prior art, a number of embodiments of a unit for thermal treatment of slabs and a plant for manufacturing slabs will be described below with the aid of the attached figures. In particular:

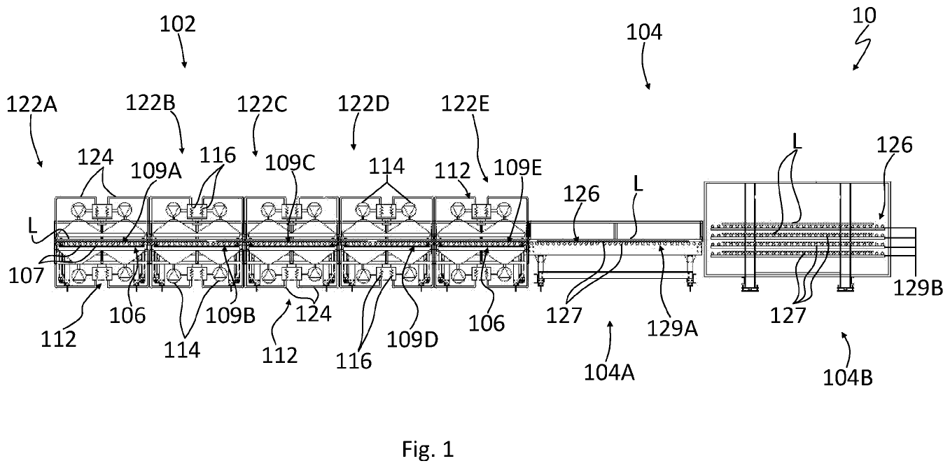

FIG. 1 is a cross-sectioned front view of a thermal treatment unit according to the present invention;

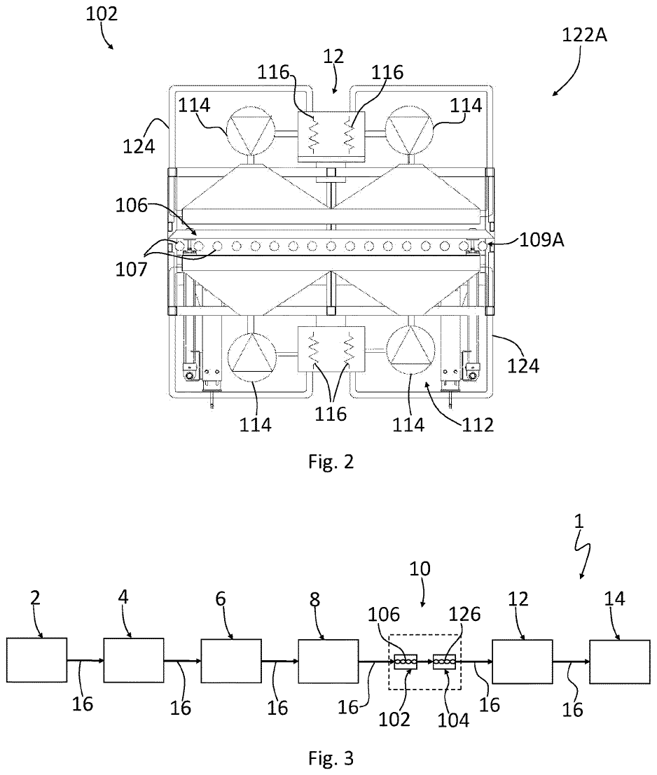

FIG. 2 is a cross-sectioned front view of a detail of the thermal treatment unit according to FIG. 1;

FIG. 3 is a schematic representation of the plant for manufacturing slabs comprising the unit for thermal treatment of the slabs according to the present invention.

The present description, provided merely by way of a non-limiting illustration of the scope of protection of the invention, relates to a unit and a method for thermal treatment of slabs L made of stone or stone-like agglomerate material.

In particular the slabs L are obtained from at least one mix, said mix comprising a binder, preferably of the organic type, namely a binding resin, and stone or stone-like granulated and/or pulverized materials.

Preferably, the binder consists of a hardening resin, for example, included in the group comprising polyester, acrylic, epoxy and polyurethane resins, but also resins of natural or plant origin; typically a polyester resin containing suitable catalysts and accelerators is used.

The granulated and/or pulverized materials of the at least one mix may be preferably obtained from minerals such as quartz, cristobalite, feldspar, granite, quartzite, marble, synthetic minerals, such as frits, or expanded materials such as expanded glass or expanded clay or expanded natural silicates.

The volumetric content of binding resin with respect to the overall volume of the mix is not greater than 25-26% and corresponds to a weight content of binding resin with respect to the overall weight of the mix of not more than 12-13%.

The mixes may also contain fillers, further binders, additives and colouring agents. In particular, the mineral fillers are materials used in combination with the binder in order to form the so-called binding paste.

The thermal treatment unit, denoted by the reference number 10 in FIG. 1 and in the schematic view of FIG. 3, is intended to be located in a plant 1 for manufacturing slabs L made of stone or stone-like agglomerate material.

The plant 1, comprising the thermal treatment unit 1 according to the present invention, also forms the subject of the invention and is shown in its entirety in the schematic view of FIG. 3.

In particular, the thermal treatment unit 10 is intended to be positioned in the plant 1 downstream of a station 6 for catalysis of the organic binder and for hardening of the mix and upstream of a station 12 for final cooling of the slabs L.

The station 6 performs the catalysis of the organic binder at a predefined catalysis temperature, nowadays usually ranging between 105° C. and 115° C. and preferably equal to about 110° C. for mixes with polyester resins.

Such temperature is higher than the temperature used in the past to perform the catalysis of the organic binder, in order to increase the productivity of the plant 1.

Furthermore, the at least one mix intended to undergo catalysis and hardening is positioned in the respective station 6 inside casings consists preferably of sheaths or moulds comprising a bottom or tray closed at the top by a cover.

The catalysis station 6 and the cooling station 12 will be described in greater detail further below with reference to the plant 1.

In accordance with a particular aspect of the invention, the thermal treatment unit 10 comprises two stations:
a first heating station 102 located at the front and comprising heating means 112 designed to heat the slabs L up to a predefined heating temperature greater than the predefined catalysis temperature indicated above;
a second cooling station 104 located downstream of the first heating station 102 and comprising cooling means designed to cool the slabs L down to a predefined cooling temperature lower than the predefined heating temperature.

Such predefined heating temperature is at least a few degrees higher than a “relaxation temperature” or “softening temperature” of the slabs, namely the temperature at which the slabs soften and are therefore deformed under the action of their own weight force.

The use of a predefined heating temperature therefore allows the slabs to become deformed and assume the form of the support surface, which is preferably flat and on which they are placed, said support surface being provided in the first heating station 102.

The softening of the slab also results in the reduction of the tension inside the slab and allows it to assume a perfectly flat form.

Said predefined heating temperature depends, in a similar manner to the predefined catalysis temperature, on the type of resin used in the mixes, the type of catalyst and accelerating agent contained in the resin, the thickness of the hardened slab to be obtained, but also the granulated or pulverized stone or stone-like material content and usually ranges between 120° C. and 160° C. but more often between 130° C. and 145° C. for polyester resins.

Said predefined heating temperature values also allow the quantity of free and non-crosslinked styrene monomer present in the slabs obtained from polyester resins to be reduced to values of less than 5 ppm with respect to the overall weight of the slabs.

Conveniently, the first heating station 102 comprises at least one module 122A, 122B, 122C, 122D, 122E preferably consisting of a hot-air oven and the heating means 112 of the at least one module 122A, 122B, 122C, 122D, 122E are designed to heat the slabs L to the predefined heating temperature ranging preferably between 120° C. and 160° C. and even more preferably between 130° C. and 145° C.

As illustrated more clearly in FIG. 1, the first heating station 102 may comprise a plurality of modules 122A, 122B, 122C, 122D, 122E arranged in succession along the direction of feeding of the slabs L (from left to right in FIG. 1), said modules 122A, 122B, 122C, 122D, 122E being formed by hot-air ovens with respective heating means 112.

FIG. 1 shows five modules 122A, 122B, 122C, 122D, 122E of the first heating station 102; however, the number of modules may also be different without thereby departing from the scope of protection of the invention.

The heating means 112 considered as a whole are designed to heat the slabs L up to the predefined heating temperature ranging preferably between 120° C. and 160° C. and even more preferably between 130° C. and 145° C.

In particular, and as shown more clearly in FIGS. 1 and 2, the heating means 112 comprise fans 114 and electric resistances 116 and the at least one module or modules 122A, 122B, 122C, 122D, 122E each comprise a pair of sections 124, each section 124 comprising at least one pair of fans 114 and at least one pair of electric resistances 116.

The fans 114 are intended to create inside each module 122A, 122B, 122C, 122D, 122E a constant air flow for keeping the temperature inside the first heating station 102 constant.

In accordance with an alternative embodiment, not shown in the figures, the heating means 112 may comprise heating pipes supplied with a hot fluid.

The first heating station 102 also comprises means 106 for moving the slabs L, said movement means 106 consisting preferably of rollers 107 arranged perfectly level so as to form respective roller conveyors or rollerways 109A, 109B, 109C, 109D, 109E which are located in the various modules 122A, 122B, 122C, 122D, 122E, as shown in FIGS. 1 and 2.

Advantageously, the rollers 107 are arranged close together with an interaxial distance of not more than 130 mm, so as to form a perfectly flat support surface on which the slabs L are formed, assuming a perfectly flat form following heating and consequent softening. Furthermore, the diameter of the rollers 107 may be close to 60 mm.

In the embodiment shown in FIG. 1, the movement means 106 allows the movement of a slab in each module 122A, 122B, 122C, 122D, 122E of the first heating station 102 so as to perform the heating step simultaneously on a plurality of slabs L and increase the productivity of the first heating station 102.

As can be seen more clearly in FIG. 2, for each section 124 of the at least one module or modules 122A, 122B, 122C, 122D, 122E, some of the fans 114 and the electric resistances 116 are located above the support surface while other fans 114 and electric resistances 116 are located below the support surface.

Conveniently, the cooling of the slabs inside the second cooling station 104 is performed by means of an air flow, preferably at room temperature, and the corresponding cooling means may comprise, where necessary, a series of fans (not shown in the attached figures) intended to generate and maintain said air flow inside the second cooling station 104.

The predefined cooling temperature is such that the slabs L are again hardened and acquire a rigidity such that they may be handled and/or inserted in the station 12 for final cooling.

In particular, the predefined cooling temperature is preferably less than 110° C.-100° C. and preferably less than 110° C.

Furthermore, the second cooling station 104 also comprises associated movement means 126, of the type described above with reference to the first heating station 102, and preferably consisting of rollers 127 arranged level so as to form roller conveyors or rollerways 129A, 129B.

The rollers 127 of the second cooling station 104 may have a diameter of about 60 mm and are also arranged close together at an interaxial distance of not more than 130 mm so as to form a support surface which is perfectly flat in order to keep the slabs L in a perfectly flat condition.

Obviously, the movement means provided in the first heating station 102 and in the second cooling station 104 may also be different from those indicated above, provided that they act as a stable and perfectly flat support surface for the advancing slabs.

As shown in FIG. 1, the second cooling station 104 comprises a first portion 104A located at the front with a single rollerway 129A and a second portion 104B located downstream of the first portion 104A and consisting of a transit cooling station with a plurality of superimposed rollerways 129B.

The fans of the cooling means described above may be positioned both in the first portion 104A and in the second portion 104B of the second cooling station 104.

Advantageously, the single rollerway 129A of the first portion 104A is fixed heightwise and is aligned with the movement means 106 of the first heating station 102.

The superimposed rollerways 129B of the second portion 104B, i.e. of the transit cooling tower, are movable along the vertical direction so as to be adjustable heightwise and are designed to be alternately aligned at the entry point with the single rollerway 129A of the first portion 104A and at the exit with the remaining part of the downstream production line.

In this respect, it is pointed out that in the embodiment shown in FIG. 1, the transit cooling tower of the second portion 104B comprises four superimposed rollerways 129B; however, said number of rollerways may also be different, for example smaller or greater.

In an alternative embodiment, the transit cooling tower may be replaced with a cooling tunnel, of the type known per se.

In accordance with a further alternative embodiment (not shown in the attached figures), the first rollerway 129B is mounted on a slab loading elevator located at the entrance of the transit cooling tower of the second portion 104B so as to raise the slab until level with the desired rollerway 129B of the transit cooling tower.

Similarly, at the exit from the transit cooling tower of the second portion 104B, a slab unloading elevator may be present in order to pick up a slab from any of the superimposed rollerways 129B of the transit cooling tower and then align the slab with the remainder of the downstream line.

Conveniently, the rollers 127 of the single rollerway 129A of the first portion 104A and the rollers 127 of the superimposed rollerways 129B of the second portion 104B of the second cooling station 104 rotate with a periodically alternating direction of rotation.

This arrangement allows the slabs L to be moved alternately in the two forwards and backwards directions of movement and thus prevent the slabs L from being deformed under their own weight at the support points.

In fact, should the rollers 127 of the rollerways 129A, 129B not rotate with an alternating movement, the slabs L would rest always on the same points and this would result in the risk of bowing occurring at the points where they are supported on the rollers 127. On the other hand, by constantly varying the support points, the slabs L are kept in a perfectly flat condition.

Conveniently, the slabs L are kept in the transit cooling tower until their temperature falls below the predefined heating temperature and reaches the predefined cooling temperature, preferably below 110° C.-100° C.

At this point, the slabs L are again hardened and acquire a sufficient rigidity that they may be handled and/or introduced into the station 12 of the plant 1 for final cooling.

The plant 1 for manufacturing slabs made of stone or stone-like agglomerate material comprises in succession, upstream of the thermal treatment unit 10 described above, at least the following stations:
a station 2 comprising means for distributing the at least one mix on a temporary support, such as a tray of a sheath, the tray containing the mix being then closed at the top by a cover;
a station 4 comprising means for compacting the at least one mix;
a station 6 comprising means for the catalysis of the binder and for hardening the mix at a predefined catalysis temperature so as to obtain hardened slabs;
   and, downstream of the thermal treatment station 10 described above:
a station 12 comprising means for final cooling of the slabs.

As already mentioned, the thermal treatment unit 10 is positioned between the catalysis station 6 and the station 12 for final cooling of the slabs.

Furthermore, the plant 1 for manufacturing slabs may also comprise a station 8 comprising means for removing the tray and the cover from the hardened slabs, such station 8 being located between the catalysis station 6 and the station 12 for final cooling of the slabs.

Advantageously, the thermal treatment unit 10 is positioned between the station 8 for removal of the trays and the covers and the station 12 for final cooling of the slabs.

The station 8 preferably comprises a unit for removal of the tray and a unit for removal of the cover.

The cover removal unit may comprise essentially a pick-up device designed to grip one edge of the cover and to wrap it around a large-diameter roller; the tray removal unit may comprise a suction-cup pick-up device designed to grip and raise the slab from the tray in order to position it on the rollers 107 of the thermal treatment unit 10, in particular of the first heating station 102, while the tray is deviated out of the line.

The station 12 for final cooling of the slabs L may consist preferably of a cooling tower or a cooling tunnel.

Furthermore, the station 12 for final cooling of the slabs L may be of the type described in European patent No. EP1893397 and may comprise a series of superimposed shelves. Moreover, the cooling tower of the station 12, where present, differs from the transit cooling tower of the second portion 104B described above in that the slabs L exit therefrom at a temperature close to the ambient temperature, i.e. at a temperature lower than the temperature of the slabs which exit from the transit cooling tower.

Downstream of the final cooling station 12 the plant 1 may comprise also a station 14 equipped with means for machining the surfaces of the slabs, for example by means of calibration and/or smoothing and/or polishing.

The station 2 for distributing the at least one mix, the station 4 for compacting the at least one mix, the station 6 for catalysis of the binder and for hardening of the mix and the station 14 for machining the surfaces of the slabs are of the known type, in particular with reference to the Bretonstone® production process and, as such, will not be further described below.

The slabs L may be transferred between one station and the next in the plant 1 and, in particular, between the compaction station 4 and the catalysis station 6, between the catalysis station 6 and the station 8 for removal of the trays and the covers, between the station 8 and the first heating station 102, between the first heating station 102 and the second cooling station 104, between the second cooling station 104 and the station 12 for final cooling of the slabs, and between the station 12 for final cooling of the slabs and the station 14 for machining the surfaces of the slabs, by means of suitable feeding means 16, such as conveyor belts or rollerways of the type indicated above, or by means of one or more operators with the aid of suitable transfer devices.

Said feeding means 16 are shown schematically in FIG. 3.

The method according to the present invention is performed downstream of a step for catalysis of the binder and hardening of the mix at the predefined catalysis temperature and upstream of a step for final cooling of the slabs and comprises the following steps:
heating the slabs to a predefined heating temperature higher than the predefined catalysis temperature;
cooling the slabs to a predefined cooling temperature lower than the predefined heating temperature.

As already mentioned with reference to the thermal treatment unit 10, the predefined catalysis temperature ranges between 105° C. and 115° C. and the predefined heating temperature, which is at least a few degrees higher than the “relaxation temperature” or “softening temperature” of the slabs, ranges preferably between 120° C. and 160° C. and even more preferably between 130° C. and 145° C.

Furthermore, the heating step, performed inside the first heating station 102 of the thermal treatment unit 10, has a duration of about 10 to 15 minutes.

The predefined cooling temperature of the respective step is such that the slabs L are hardened again and acquire a rigidity such that they may be handled, and is preferably less than 110° C. to 100° C. and preferably less than 110° C.

As already mentioned above, the method according to the present invention may be performed also downstream of a step for removal of the trays and the covers from the hardened slabs, said step being performed following the catalysis step and upstream of the step for final cooling of the slabs.

It is pointed out that the slabs used in the present invention may also be obtained from several mixes which are different from each other and may have chromatic effects obtained by means of inks and/or veining in the thickness.

From the above description it is now clear how the unit and method for thermal treatment of slabs as well as the plant for manufacturing the slabs are able to achieve advantageously the predefined objects.

In particular, the heating step at the predefined heating temperature, at least a few degrees higher than the “relaxation temperature” or “softening temperature” of the slabs, after the binder catalysis and mix hardening steps and the subsequent cooling step down to a predefined cooling temperature lower than the predefined heating temperature, are able to reduce significantly the presence of concavities/convexities on the surfaces of the slabs or internal tension within the slabs which may form following the compaction and catalysis step.

This advantageous feature limits greatly the removal of material from the surfaces of these slabs during the following machining steps, in particular during the calibration step. In particular, it is pointed out that the slabs obtained at the end of the thermal treatment performed by means of the unit and the method according to the present invention have an excess thickness of about 2-3 mm and therefore require removal of material during the calibration step which is limited to about 1.0-1.5 mm for each surface.

Said thickness of the material to be more removed is decidedly less than the average thickness which must be removed, i.e. equal to about 5-6 millimetres, in the slabs obtained by means of the methods known in the sector.

Furthermore, owing to the special measures described above, it is possible to limit significantly the residual quantity of free and non-crosslinked styrene monomer present in the slabs containing polyester resins at the end of cooling thereof.

Obviously, the above description of embodiments applying the innovative principles of the present invention is provided by way of example of these innovative principles and must therefore not be regarded as limiting the scope of the rights claimed herein.

1. A unit for thermal treatment of slabs made of stone or stone-like agglomerate material obtained from at least one mix comprising an organic binder and stone or stone-like granulated and/or pulverized materials, wherein said thermal treatment unit is intended to be positioned in a plant for manufacturing slabs made of stone or stone-like agglomerate material downstream of a station for catalysis of the organic binder and hardening of the at least one mix at a predefined catalysis temperature and upstream of a station for final cooling of the slabs;
said unit being characterized in that it comprises two stations, a first heating station located at the front and comprising heating means designed to heat the slabs up to a predefined heating temperature higher than the predefined catalysis temperature and a second cooling station located downstream of the said first heating station and comprising cooling means designed to cool the slabs down to a predefined cooling temperature lower than the predefined heating temperature.

2. The thermal treatment unit according to claim 1, characterized in that said first heating station comprises at least one module consisting of a hot-air oven, the heating means of said at least one module being designed to heat the slabs up to a predefined heating temperature ranging between 120° C. and 160° C.

3. The thermal treatment unit according to claim 2, characterized in that said first heating station comprises a plurality of modules arranged in succession and consisting of respective hot-air ovens, the heating means of said modules being designed to heat the slabs up to a predefined heating temperature ranging preferably between 120° C. and 160° C.

4. The thermal treatment unit according to claim 2, characterized in that said heating means comprise fans and electric resistances.

5. The thermal treatment unit according to claim 1, characterized in that said first heating station and said second cooling station comprise respective movement means for moving the slabs, said movement means consisting of rollers arranged level so as to form roller conveyors or rollerways, said rollers being arranged close together so as to form a support surface for the slabs.

6-7. (canceled)

8. The thermal treatment unit according to claim 5 where said heating means comprise fans and electric resistances, characterized in that, for each section of said at least one module or said modules, some of the fans and the electric resistances are located above the support surface while other fans and electric resistances are located below the support surface.

9. The thermal treatment unit according to claim 1, characterized in that the cooling means of said second cooling station comprise a series of fans intended to create an air flow at room temperature inside said second cooling station, said cooling means being designed to cool the slabs down to the predefined cooling temperature such that the slabs are hardened again and acquire a rigidity such that they may be handled and/or inserted in the station for final cooling, the cooling temperature being less than 110° C.

10. (canceled)

11. The thermal treatment unit according to claim 1, characterized in that said second cooling station comprises a first portion located at the front with a single rollerway and a second portion located downstream of said first portion and formed by a transit cooling tower with a plurality of superimposed rollerways designed to be moved along the vertical direction.

12. The thermal treatment unit according to claim 11, characterized in that the rollers of the rollerways of the first portion and of the second portion of said second cooling station rotate with a direction of rotation which periodically alternates so as to move alternately the slabs in the two directions of forwards and backwards movement.

13. A plant for manufacturing slabs made of stone or stone-like agglomerate material from at least one mix comprising an organic binder and stone or stone-like granulated and/or pulverized materials, the plant comprising at least the following stations:
a station comprising means for distributing the at least one mix on a temporary support, such as a tray of a sheath, the tray containing the mix being then closed at the top by a cover;
a station comprising means for compacting the at least one mix;
a station comprising means for the catalysis of the binder and for hardening the at least one mix at a predefined catalysis temperature so as to obtain hardened slabs;
a station comprising means for final cooling of the hardened slabs;
characterized in that the plant comprises a unit for thermal treatment of the slabs located downstream of said catalysis and hardening station and upstream of said station for the final cooling of the slabs, said thermal treatment unit comprising a first heating station located at the front and comprising heating means designed to heat the slabs up to a predefined heating temperature higher than the predefined catalysis temperature and a second cooling station located downstream of said first heating station and comprising cooling means designed to the cool the slabs down to a predefined cooling temperature lower than the predefined heating temperature.

14. The plant according to claim 13, characterized in that said first heating station comprises at least one module consisting of a hot-air oven, said heating means of said at least one module being designed to heat the slabs up to a predefined heating temperature ranging between 120° C. and 160° C.

15. The plant according to claim 14, characterized in that said first heating station comprises a plurality of modules arranged in succession and consisting of respective hot-air ovens with respective heating means, the heating means of said modules being designed to heat the slabs up to a predefined heating temperature ranging between 120° C. and 160° C.

16. The plant according to claim 14, characterized in that said heating means comprise fans and electric resistances.

17. The plant according to claim 13, characterized in that said first heating station and said second cooling station comprise respective movement means for moving the slabs, said movement means consisting of rollers arranged level so as to form roller conveyors or rollerways, said rollers being arranged close together so as to form a support surface for the slabs.

18. (canceled)

19. The plant according to claim 17, where said heating means comprise fans and electric resistances, characterized in that, for each section of said at least one module or said modules, some of the fans and electric resistances are located above the support surface while other fans and electric resistances are located below the support surface.

20. The plant according to claim 13, characterized in that the cooling means of said second cooling station comprise a series of fans intended to create an air flow at room temperature inside said second cooling station, said cooling means being designed to cool the slabs down to the predefined cooling temperature such that the slabs are hardened again and acquire a rigidity such that they may be handled and/or inserted in the station for final cooling, the predefined cooling temperature is less than 110° C.

21. (canceled)

22. The plant according to claim 13, characterized in that said second station comprises a first portion located at the front with a single rollerway and a second portion located downstream of said first portion and consisting of a transit cooling tower with a plurality of superimposed rollerways designed to be moved along the vertical direction.

23. The plant according to claim 22, characterized in that the rollers of the rollerways of the first portion and of the second portion of said second cooling station rotate with a direction of rotation which periodically alternates so as to move alternately the slabs in the two directions of forwards and backwards movement.

24-26. (canceled)

27. A method for thermal treatment of slabs made of stone or stone-like agglomerate material obtained from at least one mix comprising an organic binder and stone or stone-like granulated and/or pulverized materials, the method being performed downstream of a step for catalysis of the binder and hardening of the mix at a predefined catalysis temperature and upstream of a step for final cooling of the slabs, characterized in that the method comprises the following steps:
heating the slabs to a predefined heating temperature higher than said predefined catalysis temperature;
cooling the slabs to a predefined cooling temperature lower than said predefined heating temperature.

28. The m method according to claim 27, characterized in that said predefined heating temperature is at least a few degrees higher than a “relaxation temperature” or “softening temperature” of the slabs and preferably ranges between 120° C. and 160° C.

29. The m method according to claim 27, characterized in that said predefined cooling temperature is such that the slabs are hardened again and acquire a rigidity such that they may be handled, and is less than 110° C. ° C.

30. The m method according to claim 27, characterized in that said heating step has a duration of between 10-15 minutes.
